(19) United States
(12) Patent Application Publication
(10) Pub. No.: US 2010/0000507 A1
(43) Pub. Date: Jan. 7, 2010

(54) ANGLE CUT ON CVD DIAMOND

(75) Inventors: Robert C. Linares, Sherborn, MA (US); Patrick J. Doering, Holliston, MA (US)

Correspondence Address: SCHWEGMAN, LUNDBERG & WOESSNER, P.A., P.O. BOX 2938, MINNEAPOLIS, MN, 55402, US

(73) Assignee: Apollo Diamond Gemstone Corporation, Framingham, MA (US)

(21) Appl. No.: 12/463,132

(22) Filed: May 8, 2009

Related U.S. Application Data
(60) Provisional application No. 61/051,884, filed on May 9, 2008.

(51) Int. Cl. B28D 5/00; A44C 17/00

(52) U.S. Cl. 125/30.01; 63/32

(57) ABSTRACT

A cut gemstone has one or more backside grooves cut into backside facets to form sub facets that operate to increase the brilliance of the cut gemstone.

### CROSS-REFERENCE TO RELATED APPLICATIONS

This application claims priority to U.S. Provisional Application Ser. No. 61/051,884, filed May 9, 2008, the entire disclosure of which is incorporated by reference herein.

### BACKGROUND

The fire and sparkle of diamond is a result of the high index of refraction, the high dispersion and the angle of the cut on the back surface. The ideal ratios of diameter and depth have been established and result in back surfaces that have an angle between them of approximately forty two degrees. For some types of stones, a round brilliant cut provides angles that tend to reflect light back out the top of the stone. Diamonds that lack depth generally have cuts that result in back surfaces that fail to achieve desired reflection, and hence lack some of the fire and sparkle that thicker cut stones achieve.

### BRIEF DESCRIPTION OF THE DRAWINGS

FIG. 1 is a prior art diagram of an ideal cut diamond.

FIG. 2 is a representation of a cut gemstone having a groove cut on the backside of the gemstone according to an example embodiment.

FIG. 3 is a representation of a cut gemstone having multiple grooves cut on the backside of the gemstone according to an example embodiment.

FIG. 4 is a top view representation of a backside facet showing multiple grooves according to an example embodiment.

FIG. 5 is a cross section of a grinding or polishing wheel according to an example embodiment.

FIG. 6 is a representation of groove angles and a table of ranges for such groove angles to provide desired brilliance of a diamond according to an example embodiment.

FIG. 7 is a cross section representation of a diamond having grooves for providing a retro reflector according to an example embodiment.

FIG. 8 is block representation of angles between multiple grooves on a backside facet of a diamond according to an example embodiment.

FIG. 9 is block representation of a further arrangement of angles between multiple grooves on a backside facet of a diamond according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

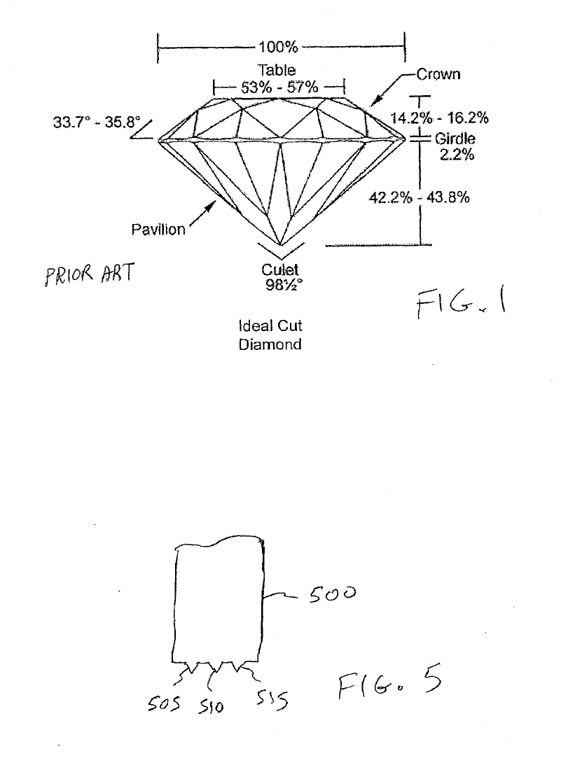

The fire and sparkle of a gemstone, such as a diamond is a result of the high index of refraction, the high dispersion and the angle of the cut on the back surface. The ideal ratios of diameter and depth have been established and result in back surfaces of approximately ninety eight degrees. An ideal round brilliant diamond cut is illustrated in PRIOR ART FIG. 1. Of course this is unattainable for thin, flat stones that may have a similar diameter, but not nearly the depth needed to support an ideal round brilliant diamond cut.

In various embodiments, one or more angles are determined for a back side groove on one or more backside facets of a cut diamond to obtain an increase in brilliance of the cut diamond. The backside grooves are formed to create sub facets on one or more backside facets of the cut diamond in accordance with the determined one or more angles. In one embodiment, as shown in FIG. 2 at 100, a rear facet of 98 or other desired angle may be obtained on the back side of a diamond by cutting and polishing a groove 110 on the back side of the diamond which has the requisite angle indicated at 115. Moreover, the backside can be covered with a series of such grooves and grooves at various angles to one another to cover the entire backside with reflecting and dispersing surfaces. The multiple facets that are cut into the backside in one embodiment, provide for total internal reflection of light, resulting in light being reflected back out a top surface 120 of the diamond.

Given a diamond crystal of 1 cm square, such a crystal will weigh 1.7 carats per millimeter of thickness. For an ideal cut diamond brilliant, the crystal would need to 7 mm thick and would yield a 3 ct stone. If however, the stone were 3 mm thick and cut with inverted back facets—the groove described above, it would be over 3 ct in weight and as beautiful as the round brilliant. The advantages become quite compelling when considering stones of one inch square wherein the weight is 10 carats per mm of thickness. Therein, a stone of 3 mm thickness would weigh 30 ct and yield a cut stone of 25 carats. The value of a cut stone depends, in part, on it's weight and brilliance with heavier and more brilliant stones having higher value.

In one embodiment, a plate of single crystal chemical vapor deposition (CVD) grown diamond may be used to provide raw diamond for cutting into various shapes. As indicated above, a round brilliant cut diamond may be obtained, but the overall size of such a cut diamond will be limited by the thickness of the plate. In one embodiment, a laser may be used to cut the plate into a desired shape, such as a rectangle or circle or other desired shape.

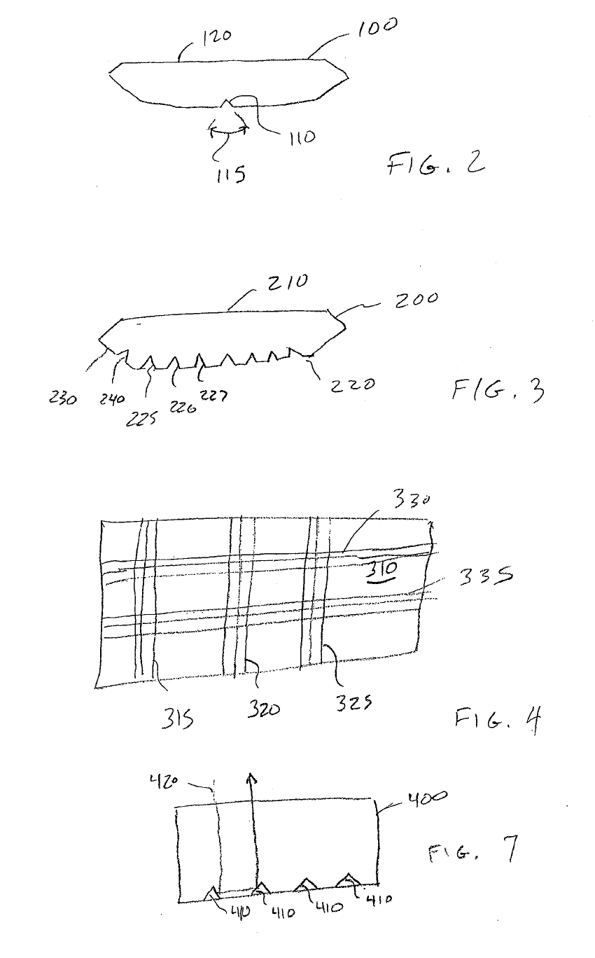

The resulting cut diamond may be further cut by laser to obtain one of the classic cuts, such as a rose cut, emerald cut or other known cut. New cuts of diamond may also be used. FIG. 3 illustrates a further embodiment of a cut gemstone CVD diamond at 200. Diamond 200 has a top side 210 and a back side 220 of the diamond may then have one or more grooves 225, 226, 227 cut into one or more back side facets, backside 220 being one large facet. A further backside facet 230 is shown with an addition groove 240 to illustrate that any number of backside facets may have groove therein to form sub facets with a desired angle to the top side 210.

In one embodiment, the grooves may be cut by the use of a polishing or grinding wheel, which may have a “V” shape to it. The angle of the V shape of the groove and orientation of the groove on the surface of each backside facet may be varied to obtain sub facets that result in the sub facets having an angle with respect to a top surface of the cut diamond of approximately 41°. Other angles may be used as desired. In some embodiments, multiple different grinding wheels with different angles may be used to cut grooves in facets as a function of the angle of the facet being cut with respect to the top surface of the diamond. Multiple grooves may be cut simultaneously by using a grinding or polishing wheel with multiple V-shaped protrusions. The grinding or polishing wheel surface geometry may be tailored to create the desired number, depth, spacing, and angle of the groove(s). In further embodiments, grooves may be cut in back side facets to obtain desired angles with respect to other surfaces of the diamond, such as surfaces adjacent to the top surface (sometimes referred to as the table) of the diamond. As used herein the top surface of the diamond is a primary surface that is viewable when the diamond is mounted in a setting or other device. The top surface may also be faceted in some embodiments, or generally flat. Backside surfaces or facets are basically opposite the top surface.

In one embodiment, the grooves are cut approximately 100 um deep. The apex of the groove, where sides of the grooves meet, need not be a sharp angle. It may be somewhat rounded in some embodiments, which may actually result in maintaining the integrity and durability of the diamond. Multiple such grooves may be cut in selected backside facets. In various embodiments, the grooves are spaced as closely as possible to ensure more light is reflected back out the top surface of the diamond. The density of the grooves may be limited to ensure that the resulting diamond is not too brittle. Thus, mechanical considerations may limit the type and density of the grooves in some embodiments.

FIG. 4 is a top view representation of a backside facet 310 showing multiple grooves 315, 320, 325 according to an example embodiment. Some of the grooves may be parallel, while others 330, 335 may be at angles to the parallel grooves, such as at a right angle, or 60° angle, or yet other angles as desired. While the depth of the grooves in one embodiment is approximately 100 um deep, many other depths of grooves may be formed if desired. Shallower grooves allow for a higher density of grooves to be cut. Larger grooves may be used if desired. The number and depth of the grooves may be significantly varied for each stone to be grooved.

The use of such grooves on selected back side facets allows very flat stones to be made that may approach, reach, or exceed the brilliance of classical brilliant cut stones. While the cuts are described as being made to diamonds formed using CVD processes, which may be single crystalline in structure, the grooves may also be used in natural stones. One benefit of using thin diamond slabs while obtaining desired brilliance is that the weight of the resulting stone may be less than that of a similar looking stone having a regular brilliant cut. The extra weight added by the additional depth of the stone to obtain a brilliant cut may not be desired for some jewelry, such as earings.

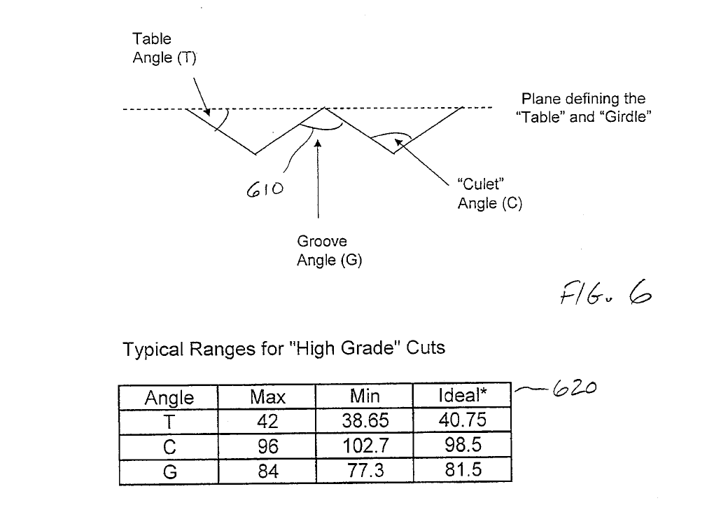

A grinding wheel has been described for making the cuts. Other methods may be used in further embodiments, such as selective etching, laser or yet other devices. FIG. 5 is a cross section of a grinding wheel 500 having a surface with multiple v shaped protrusions 505, 510, 515, which when applied to a gemstone create multiple substantially parallel grooves designed to increase the brilliance of the gemstone. The angles of the protrusions or surface geometry is consistent with the above description for forming grooves that promote brilliance in a gemstone such as a diamond. Various embodiments of protrusions may be used, such as three spaced protrusions as shown, directly adjacent protrusions, with no flat surface between them, and surfaces with many more protrusions. As indicated above, different grinding or polishing wheels may have different angle protrusions depending on the surface or facet of the gemstone on which grooves are to be formed to optimize internal reflections of light.

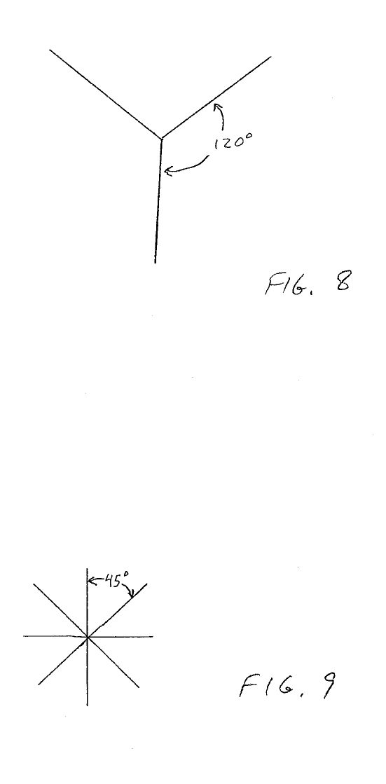

FIG. 7 is a representation of groove angles and a table of ranges for such groove angles according to an example embodiment. A groove angle (G) at 610 is formed as described by a grinding or polishing wheel in one embodiment. Table 620 illustrates typical ranges for various parameters regarding the grooves, including maximum, minimum and ideal angles with respect to the grooves. A culet angle (C) at 630 is an angle between two adjacent sub facets grooves, and a table angle (T) at 640 is an angle between one face of a groove and a top or table surface of a gemstone. In one embodiment, T may ranges from 42 to 38.65 degrees, with an ideal of 40.75 degrees. C may range from 96 to 102.7 degrees with an ideal of 98.5, and G may range from 84 to 77.3 degrees with an ideal of approximately 81.5 degrees. These angles are typical ranges for high grade cuts, and may be varied in further embodiments.

In one embodiment, one or more grooves 410 may be formed to create a retro reflector out of a diamond 400 as shown in cross section in FIG. 7. In a retro reflector, the grooves may be formed to reflect light 420 received on the top surface, between sub facets of the grooves, and back out the top surface. Such devices may be useful in optical devices, such as high power laser devices. The grooves may form sub facets that may be 90° apart, 120° apart as shown in FIG. 8, 45° apart as shown in FIG. 9, or yet other angles as desired. More than two sub facets may be used to provide the total reflection. A single backside facet 430 is show in FIG. 4, that is substantially parallel to the top surface, allowing the use of two sub facets to reflect the light. If additional backside facets are formed at different angles, two or more sub facets may be used to provide the desired reflection from such backside facets.

The Abstract is provided to comply with 37 C.F.R. §1.72(b) to allow the reader to quickly ascertain the nature and gist of the technical disclosure. The Abstract is submitted with the understanding that it will not be used to interpret or limit the scope or meaning of the claims.

What is claimed is:

1. A method comprising:
determining one or more angles for a back side groove on one or more backside facets of a cut diamond to obtain an increase in brilliance of the cut diamond;
cutting one or more backside grooves to form sub facets on one or more backside facets of the cut diamond in accordance with the determined one or more angles.

2. The method of claim 1 wherein the grooves have an angle of approximately 81.5° between the sides of the grooves forming the sub facets.

3. The method of claim 1 wherein the grooves have an angle of between 84 to 77.3 degrees between the sides of the groove forming the sub facets.

4. The method of claim 1 wherein multiple substantially parallel grooves are cut on a backside facet.

5. The method of claim 4 wherein additional grooves are cut at a desired angle from the multiple substantially parallel grooves on the backside facet.

6. The method of claim 1 wherein the grooves are cut to a depth of approximately 100 um.

7. The method of claim 1 wherein the grooves have an angle between sides of the groove that can be varied from facet to facet and from angle of the grove on the facet.

8. The method of claim 1 wherein the grooves are formed using a grinding wheel.

9. A method comprising:
determining an angle for a sub facet of a back side groove on a selected backside facet of a cut diamond to obtain an increase in brilliance of the cut diamond;
cutting the backside groove such that at least one sub facet of the groove has the determined angle with respect to a top surface of the cut diamond.

10. The method of claim 9 wherein the cut diamond comprises a CVD formed single crystal diamond.

11. The method of claim 9 and further comprising forming multiple such grooves on the selected backside facet.

12. The method of claim 9 wherein the grooves have an angle of between 84 to 77.3 degrees between the sides of the groove forming the sub facets.

13. The method of claim 9 wherein multiple substantially parallel grooves are cut on a backside facet.

14. A cut diamond comprising:
a top side;
multiple back side facets; and
one or more grooves cut into one or more back side facets to form sub facets having an angle with respect to the top side that results in an increase in brilliance of the cut diamond.

15. The cut diamond of claim 14 wherein the grooves have an angle of approximately 81.5° between the sides of the grooves forming the sub facets.

16. The cut diamond of claim 14 wherein the grooves have an angle of between 84 to 77.3 degrees between the sides of the groove forming the sub facets.

17. The cut diamond of claim 14 wherein multiple substantially parallel grooves are cut on a backside facet.

18. The cut diamond of claim 14 wherein the diamond is thinner than a diamond of similar diameter having an ideal brilliant cut.

19. The cut diamond of claim 14 wherein the grooves are cut to a depth of approximately 100 um.

20. An optical diamond element comprising:
a single crystal CVD grown diamond having a flat top surface;
one or more backside facets; and
one or more grooves cut in the backside facets forming multiple sub facets having angles with respect to each other that cause the diamond element to operate as a retroreflector.
